(19) United States
(12) Patent Application Publication
(10) Pub. No.: US 2015/0260564 A1
(43) Pub. Date: Sep. 17, 2015

(54) SENSOR

(71) Applicant: Yazaki Corporation, Tokyo (JP)

(72) Inventors: Shinpei KATO, Makinohara-shi (JP); Toshiaki FUKUHARA, Makinohara-shi (JP); Ryo HIROSE, Makinohara-shi (JP)

(73) Assignee: YAZAKI CORPORATION, Tokyo (JP)

(21) Appl. No.: 14/658,424

(22) Filed: Mar. 16, 2015

(30) Foreign Application Priority Data
Mar. 17, 2014 (JP) 2014-053315

(51) Int. Cl. G01F 23/72

(52) U.S. Cl. CPC G01F 23/72

(57) ABSTRACT

A sensor includes an electronic component having a conductive lead and a body portion, a first resin molded piece configured to receive and to hold the electronic component, a lead frame held by the first resin molded piece and electrically connected to the lead of the electronic component, and a second resin molded piece insert-molded with the electronic component, the first resin molded piece and the lead frame being insert parts such that a portion of the lead frame is exposed. The first resin molded piece has a recess portion at least in a wiring section in which the lead of the electronic component extends. The recess portion is filled with a potting material having an insulation property and an adhesiveness to the lead and to the first resin molded piece.

### CROSS-REFERENCE TO RELATED APPLICATIONS

The present application claims priority from Japanese Patent Application No. 2014-053315 filed on Mar. 17, 2014, the entire content of which is incorporated herein by reference.

### FIELD OF INVENTION

The present invention relates to a sensor.

### RELATED ART

There are various sensors that detect a physical quantity related to an object to be detected or an amount of a change of the object to be detected. Examples of the object to be detected include temperature, pressure and flow rate. A liquid level sensor is one of such sensors, and detects a liquid level. The liquid level sensor is configured to detect the liquid level in accordance with a behavior of a float that moves up and down in response to changes of the liquid level. For example, the behavior of the float is transmitted to an arm, and by the arm rotating, an annular magnet rotatably attached to a sensor housing is rotated. Then, the change of the magnetic flux density caused around the magnet is detected by a detection circuit provided inside the sensor housing, whereby the liquid level is detected.

Related art liquid level sensors are configured to detect a liquid level inside a tank (see, e.g., JP2008-014917A and JP2011-203022A). The liquid level sensors have a housing. The housing has a Hall integrated circuit (Hall IC) as a detection element to detect a rotation angle of a rotary portion that rotates in accordance with a behavior of a float, and lead frames to electrically connect the Hall IC to the outside. The housing is formed by insert-molding with the Hall IC and the lead frames being insert parts. The Hall IC includes a Hall element, a pre-amplifier and the like. When a magnetic field is externally applied to the Hall element in a state in which a voltage is applied to the Hall element, the Hall element generates a Hall voltage proportional to the magnetic flux density of the magnetic field passing therethrough. This Hall voltage undergoes amplification by the pre-amplifier and the like, and is transmitted to an external circuit, i.e., to an upper level device. The lead frames are each made from a conductive metal plate, and include a signal lead frame for measurement signals of the Hall IC, a grounding lead frame for grounding the Hall IC, and a power supply lead frame for a power supply to the Hall IC. The signal lead frame is connected to a signal lead extending from the body portion of the Hall IC, the grounding lead frame is connected to a grounding lead extending from the body portion of the Hall IC, and the power supply lead frame is connected to the power supply lead extending from the body portion of the Hall IC.

Further, in the liquid level sensor, if a pulse of a high voltage such as static electricity is applied to the signal lead frame and the power supply lead frame, the pre-amplifier and the like of the Hall IC can be electrically damaged. Therefore, two capacitors that electrically protect the Hall IC is attached. Specifically, one capacitor has one end thereof electrically connected to the grounding lead frame, and has the other end thereof electrically connected to the signal lead frame. The other capacitor has one end thereof electrically connected to the grounding lead frame, and has the other end thereof electrically connected to the power supply lead frame. Thereby, even when a pulse of a high voltage is input, it is not applied to the pre-amplifier and the like of the Hall IC since it flows out to the grounding lead frame through a chip capacitor. Consequently, the pre-amplifier and the like of the Hall IC can be prevented from being electrically damaged.

As described above, electronic components such as the Hall IC and the capacitors are mounted on the liquid level sensor. However, there are cases where the liquid level sensor sinks in the liquid when the liquid level to be detected is high, and in such cases, since the lead frames are partly exposed out of the housing for connection to an upper level device, there is a possibility that the liquid reaches the electronic components through a gap between the lead frames as insert parts and the housing and breaks the electronic component.

In view of this, according to another related art liquid level sensor, a rubber sealing member is provided in the housing in order to prevent the liquid from entering from the exposed parts of the lead frames (see, e.g., JP2007-315873A).

However, with this configuration, since a suitable sealing function cannot be provide unless the rubber sealing member is held in the housing in a state of being compressed, to bring the sealing member into a compressed state, additional consideration is required for bringing the sealing member into the compressed state during the molding of the housing.

This problem is common not only to liquid level sensors that are under liquid when the amount of liquid to be detected is large but also to liquid level sensors that are always under liquid. In the case of sensors that sometimes sink in liquid, this problem is common not only to liquid level sensors that detect the liquid level but also to sensors that detect a different physical or change amount such as liquid temperature.

### SUMMARY

Illustrative aspects of the present invention provide a sensor capable of preventing an electronic component from being broken by liquid entering from an exposed part of a lead frame while facilitating manufacture.

According to an illustrative aspect of the present invention, a sensor is adapted to be used in liquid and is configured to output an electric signal corresponding to a physical quantity related to an object to be detected or an amount of a change of the object to be detected. The sensor includes an electronic component having a conductive lead and a body portion, a first resin molded piece configured to receive and to hold the electronic component, a lead frame held by the first resin molded piece and electrically connected to the lead of the electronic component, and a second resin molded piece insert-molded with the electronic component, the first resin molded piece and the lead frame being insert parts such that a portion of the lead frame is exposed. The first resin molded piece has a recess portion at least in a wiring section in which the lead of the electronic component extends. The recess portion is filled with a potting material having an insulation property and an adhesiveness to the lead and to the first resin molded piece.

With this configuration, since the recess portion formed in the wiring section in which the lead of the electronic component extends is filled with the potting material having the insulation property and the adhesiveness to the lead and the first resin molded piece, even if liquid enters the second resin molded piece from the exposed part of the lead frame, the liquid is held back by the potting material in the recess portion and does not reach the body portion of the electronic component. Thereby, the electronic component can be prevented from being broken by the liquid entering from the exposed part of the lead frame without having to consider holding the rubber sealing member in a state of being compressed at the time of manufacture.

The recess portion may be formed to extend continuously to a connection point at which the lead is connected to the lead frame, and the recess portion may be filled with the potting material such that the potting material is continuously provided to include the connection point.

With this configuration, since the recess portion is formed to extend continuously to the connection point at which the lead is connected to the lead frame, and the recess portion is filled with the potting material such that the potting material is continuously provided to include the connection point, the lead of the electronic component is also covered with the potting material, so that it is possible to prevent a disconnection due to the resin exerting a load on the lead of the electronic component during the insert molding of the second resin molded piece.

The sensor may be provided in a fuel tank of an automobile, the first resin molded piece may be made of a polyphenylene sulfide resin, the second resin molded piece imay be made of a polyacetal resin, and the potting material may be made of fluorosilicone, perfluoroelastomer or perfluoroether having the adhesiveness.

With this configuration, since the first resin molded piece is made of the polyphenylene sulfide resin, the second resin molded piece is made of the polyacetal resin and the potting material is made of fluorosilicone, perfluoroelastomer or perfluoroether having the adhesiveness, expensive resins are used for the inside of the sensor. Thereby, cost can be suppressed compared with when expensive resins are used for the outside. Further, the electronic component is protected by the two-layer structure of the polyacetal resin that suppresses the penetration of gasoline and the polyphenylene sulfide resin that suppresses the penetration of moisture and alcohol, so that the possibility can be suppressed that gasoline, or ethanol or the like mixed in the gasoline penetrates into the resin to reach the electronic component and break the electronic component.

The sensor may further include a float floatable on a liquid surface; and an annular magnet configured to rotate in accordance with a position of the float, and the electronic component may be a Hall integrated circuit disposed in the center of the magnet, the Hall integrated circuit including a Hall element to output an electric signal corresponding to a change of a magnetic flux density of a magnetic field passing through the Hall element as the magnet rotates.

With this configuration, the electronic component is a Hall integrated circuit disposed in the center of the magnet and including a Hall element, and outputs an electric signal corresponding to a change of a magnetic flux density of a magnetic field passing through the Hall element as the magnet rotates. Consequently, by using a semiconductor part for the sensor, a semiconductor part more vulnerable to liquid can be protected.

In phrase “adapted to be used in liquid” described above does not necessarily mean the sensor is always under the liquid but includes a case where the sensor goes under the liquid in a certain condition (for example, when the amount of liquid becomes large).

### BRIEF DESCRIPTION OF THE DRAWINGS

FIG. 1 is a perspective view schematically illustrating a liquid level sensor according to an exemplary embodiment of the present invention;

FIG. 2 is a front view of a lead frame assembly;

FIG. 3 is a front view illustrating a state in which part of the structure of FIG. 2 is removed;

FIG. 4 is a perspective view of lead frames;

FIG. 5 is a cross-sectional view taken along the line V-V shown in FIG. 1; and

FIG. 6 is a cross-sectional view of a liquid level sensor according to a modification of the exemplary embodiment.

### DETAILED DESCRIPTION

Hereinafter, exemplary embodiments of the present invention will be described in detail with reference to the drawings. However, the following exemplary embodiments do not limit the scope of the claimed invention, and it will be understood by those skilled in the art that various changes and modifications may be made therein without departing from the scope of the present invention as defined by the appended claims. For example, while a liquid level sensor will be described below as an example of a sensor according to the present invention, the present invention is not limited to the liquid level sensor.

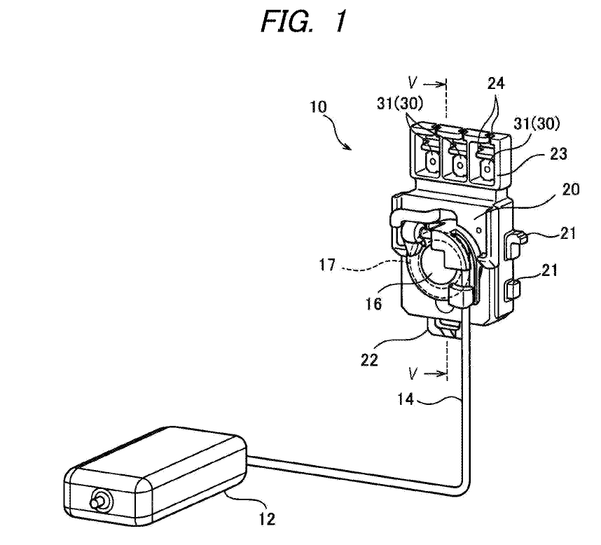

FIG. 1 is a perspective view schematically illustrating a liquid level sensor 10 according to an exemplary embodiment of the present invention. The liquid level sensor 10 is, for example, provided in a fuel tank of an automobile to be detect a liquid level of the fuel inside the fuel tank. The liquid level sensor 10 has a float 12, an arm 14, a holder 16 and a sensor housing 20 (an example of a second resin molded piece). In this exemplary embodiment, the fuel is gasoline (mainly including octane and toluene) mixed with alcohol (for example, ethanol).

The float 12 is floatable on the liquid surface, and moves up and down in response to liquid level fluctuations in the fuel tank. The arm 14 has one end thereof connected to the float 12 and has the other end thereof connected to the holder 16. The holder 16 is rotatably attached to a predetermined position of the sensor housing 20, and inside the holder 16, an annular magnet 17 is disposed.

The sensor housing 20 is insert-molded with a lead frame assembly 40 holding lead frames 30 and a Hall IC 45 (an example of an electronic component, see FIG. 3) as an insert part. In the exemplary embodiment, under a condition where only terminal portions 31 of the lead frames 30 are exposed (at least partly exposed) to the outside, the sensor housing 20 accommodates the remaining part thereof. This sensor housing 20 is made of a polyacetal resin. Instead of the polyacetal resin, a resin with an SP value of not less than 20(MJ/m³)¹² may be used.

The sensor housing 20 has a plurality of (for example, two) tabs 21 on the right and left side portions, and has a hook 22 on the lower portion. Here, the fuel tank has a pump (not shown) that sends out the fuel to the outside, and the liquid level sensor 10 is attached, for example, to a pump holder of the pump. These tabs 21 and hook 22 are capable of fixing the liquid level sensor 10 to the pump holder with no backlash by engaging with engagement members on the pump holder side.

On the sensor housing 20, a peripheral wall portion 23 formed so as to surround the terminal portion 31 is formed on an upper end portion where the terminal portions 31 of the lead frames 30 described later are exposed. By thus covering the periphery of the terminal portions 31 with the peripheral wall portion 23, leakage current generated among the terminal portions 31 can be suppressed.

On this peripheral wall portion 23, lead wire insertion portions 24 are formed by notching the peripheral wall portion 23 in the direction of the depth of the sensor housing 20. The lead wire insertion portions 24 are for fixing and holding the lead wires (conductive wires) connected to the terminal portions 31.

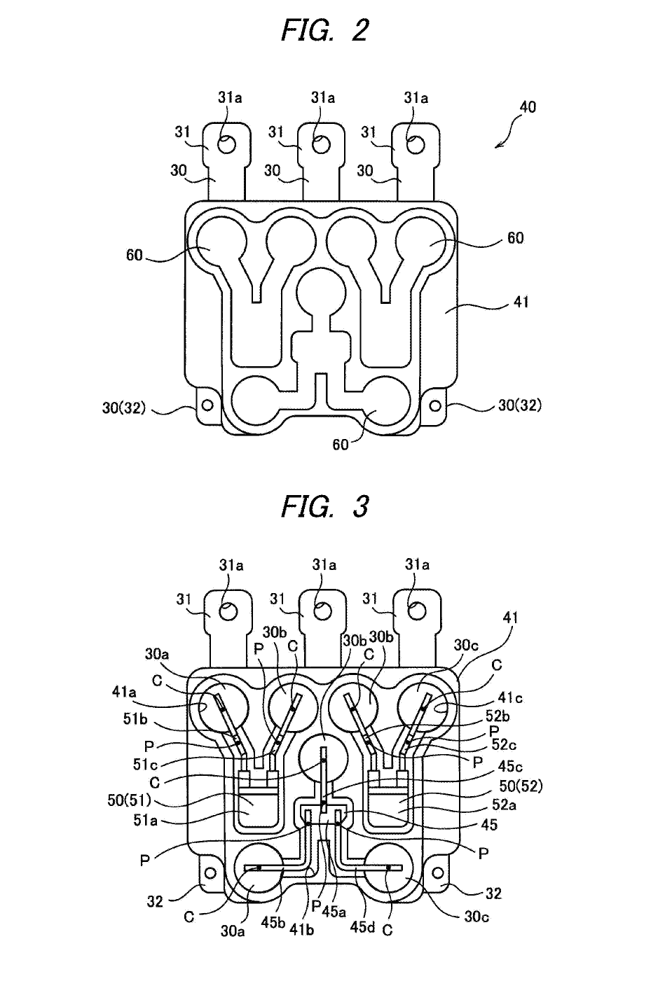

FIG. 2 is a front view of the lead frame assembly 40, and FIG. 3 is a front view showing a state in which part of the structure of FIG. 2 is removed. As shown in FIGS. 2 and 3, the lead frame assembly 40 is formed of the lead frames 30, an inner member 41 (a first resin molded piece), the Hall IC 45 and capacitors 50 (other examples of electronic component).

The Hall IC 45 is formed of a Hall element, an amplifier circuit and the like, and disposed in the center of the magnet 17. The Hall IC 45 has a body portion 45a and three leads 45b to 45d corresponding to signal, grounding and power supply, respectively. The capacitors 50 include two capacitors of a first capacitor 51 and a second capacitor 52 which have a body portion 51a and two leads 51b, 51c and a body portion 52a and two leads 52b, 52c, respectively.

The lead frames 30 are each a (conductive) circuit member formed of a metal plate for electrically connecting the Hall IC 45 to an external circuit, and may be formed of, for example, a metal plate of tinned brass, or stainless steel or iron. The lead frames 30 are prepared corresponding to the number of leads 45b to 45d provided to the Hall IC 45, and in the exemplary embodiment, three lead frames 30 are prepared. The lead frames 30 are each formed of one plate member, the terminal portion 31 is formed on a leading end side, and a base portion 32 is formed on the base end side. In the center of the terminal portion 31, a passage hole 31a for inserting the lead wire is formed. The lead wire is electrically connected, for example, by soldering after inserted through the passage hole 31a.

The inner member 41 is a resin member configured to receive and to hold at least the Hall IC 45 and the capacitors 50, and also includes the base portions 32 on the base end sides of the lead frames 30 to hold them. This inner member 41 is made of for example, a polyphenylene sulfide resin. While the inner member 41 holds the lead frames 30 by being insert-molded with the lead frames 30 as insert parts in the exemplary embodiment, the holding form is not limited to the insert molding but various forms such as the lead frames 30 being fitted in the inner member 41 may be adopted. Moreover, instead of the polyphenylene sulfide resin, an alternative material whose SP value is low with respect to the sensor housing 20 with an SP value of not more than 10(MJ/m³)^{1/2} may be used. Those alternative materials do not readily expand for ethanol with an SP value of 26.2(MJ/m³)^{1/2} and water with an SP value of 47.1(MJ/m³)^{1/2}. Expansion is a phenomenon in that a substance expands by absorbing a solvent. Thus, the alternative materials are materials that do not readily absorb ethanol and water and do not readily allow ethanol and water to pass therethrough. The easiness to expand depends on the SP value, and the closer the SP value is, the easier the expansion is and the farther the SP value is, the more difficult the expansion is.

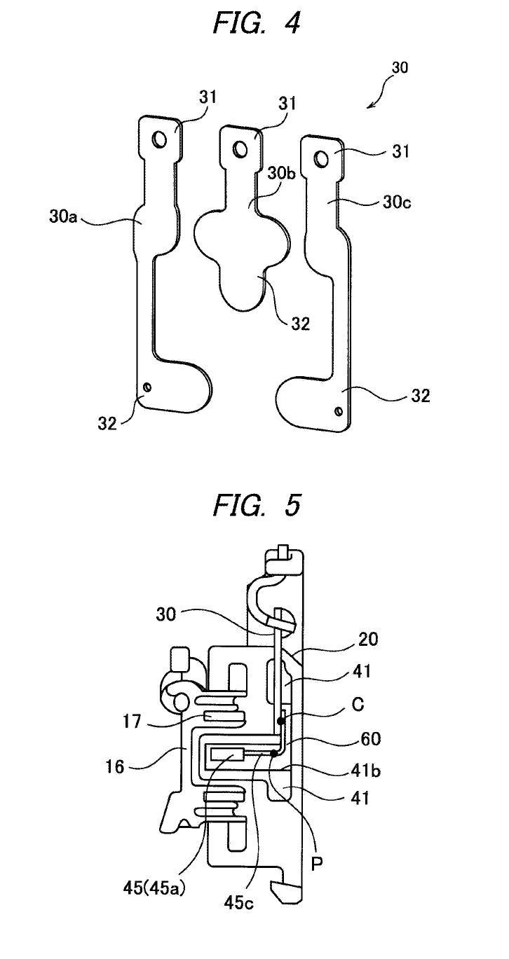

FIG. 4 is a perspective view showing the lead frames 30. More specifically, the lead frames 30 are a signal lead frame 30a for the measurement signal of the Hall IC 45, a grounding lead frame 30b for grounding of the Hall IC 45, and a power supply lead frame 30c for power supply to the Hall IC 45.

On the inner member 41, as shown in FIG. 3, a plurality of (three) recess portions 41a to 41c that are concave in the direction of the depth, that is, in the direction of the thickness of the sensor housing 20 are formed. These recess portions 41a to 41c are at least provided in wiring sections P in which the leads 45b to 45d, 51b, 51c, 52b, 52c of the Hall IC 45 and the capacitors 50 extend. More specifically, the first recess portion 41a accommodates not only the wiring section P of the first capacitor 51 but also the entire first capacitor 51. Likewise, the second recess portion 41b accommodates not only the wiring section P of the Hall IC 45 but also the entire Hall IC 45, and the third recess portion 41c accommodates not only the wiring section P of the second capacitor 52 but also the entire second capacitor 52. That is, the wiring sections P are parts of the leads 45b to 45d, 51b, 51c, 52b, 52c which parts are situated at a predetermined distance from the body portions 45a, 5 la and 52a, and the recess portions 41a to 41c are formed in positions including at least these parts. Therefore, it is said that the recess portions 41a to 41c are formed in the wiring sections P also for the mode in which the entire Hall IC 45 and the capacitors 50 are accommodated in the recess portions 41a to 41c as in the exemplary embodiment.

More specifically, the first recess portion 41a is a recess portion substantially Y-shaped when viewed from the front, the signal lead frame 30a and the grounding lead frame 30b are partly exposed from the bottom surface thereof, and the two lead frames 51b, 51c extending from the body portion 51a of the first capacitor 51 are connected to the signal lead frame 30a and the grounding lead frame 30b by welding, respectively. In particular, the first recess portion 41a is formed continuously from the part where the body portion 51a of the first capacitor 51 is accommodated up to the connection points C between the two leads 51b, 51c and the signal lead frame 30a and the grounding lead frame 30b.

The second recess portion 41b is a recess portion where the part where the body portion 45a of the Hall IC 45 is accommodated is deeply notched and the parts where the leads 45b to 45d are accommodated are shallowly notched, the signal lead frame 30a, the grounding lead frame 30b and the power supply lead frame 30c are partly exposed from the bottom surface thereof, and the three leads 45b to 45d extending from the body portion 45a of the Hall IC 45 are connected to the signal lead frame 30a, the grounding lead frame 30b and the power supply lead frame 30c by welding, respectively. In particular, the second recess portion 41b is formed continuously from the part where the body portion 45a of the Hall IC 45 is accommodated up to the connection points C between the three leads 45b to 45d and the signal lead frame 30a, the grounding lead frame 30b and the power supply lead frame 30c.

The third recess portion 41c is a recess portion substantially Y-shaped when viewed from the front like the first recess portion 41a, the grounding lead frame 30b and the power supply lead frame 30c are partly exposed from the bottom surface thereof, and the two leads 52b, 52c extending from the body portion 52a of the second capacitor 52 are connected to the grounding lead frame 30b and the power supply lead frame 30c by welding, respectively. In particular, the third recess portion 41c is formed continuously from the part where the body portion 52a of the second capacitor 52 is accommodated up to the connection points C between the two leads 52b, 52c and the grounding lead frame 30b and the power supply lead frame 30c.

Referring again to FIG. 2, as shown in FIG. 2, in the liquid level sensor 10 according to the exemplary embodiment, the recess portions 41a to 41c are filled with a potting material 60 having an insulation property and an adhesiveness to at least the leads 45b to 45d, 51b, 51c, 52b, 52c and the inner member 41. The potting material 60 is made of, for example, fluorosilicone, perfluoroelastomer having the adhesiveness or perfluoroether having the adhesiveness. Instead of fluorosilicone or the like, an alternative material whose SP value is low with respect to the sensor housing 20 with an SP value of not more than 10(MJ/m³)^{1/2} may be used. Those alternative materials are materials that do not readily expand for ethanol with an SP value of 26.2(MJ/m³)^{1/2} and water with an SP value of 47.1(MJ/m³)^{1/2}, do not readily absorb ethanol and water and do not readily allow ethanol and water to pass therethrough like the above-mentioned ones.

FIG. 5 is a cross-sectional view taken along the line V-V shown in FIG. 1. As shown in FIG. 5, the Hall IC 45 is accommodated in the second recess portion 41b, and the potting material 60 provided from the bottom surface of the second recess portion 41b to at least the wiring sections P for the leads 45b to 45d. In particular, in the exemplary embodiment, the potting material 60 is continuously provided to include the points C for connection with the lead frames 30 through the wiring sections P of the leads 45b to 45c.

Although a cross-sectional view thereof is omitted, for the first capacitor 51 and the second capacitor 52, the potting material 60 is also provided to fill the wiring sections P of the leads 51b, 51c, 52b, 52c, and in particular, in the exemplary embodiment, the potting material 60 is also continuously provided to include the points C for connection with the lead frames 30 through the wiring sections P of the leads 51b, 51c, 52b, 52c.

Next, the liquid level detection method of the liquid level sensor 10 according to the exemplary embodiment will be described. First, it is assumed that a liquid level change occurs. In this case, the float 12 moves up or down and the arm 14 rotates. Thereby, the holder 16 and the magnet 17 disposed therein are rotated.

When this occurs, the magnetic flux density of the magnetic field passing through the Hall element changes, and an electric signal (voltage signal) responsive to this change is output from the Hall IC 45. The upper level device connected through the lead frames 30 detects the liquid level based on this electric signal.

Next, the method of manufacturing the liquid level sensor 10 according to the exemplary embodiment will be described. First, in a first step, a sheet metal as the base material is punched to form three lead frames 30 as shown in FIG. 4. The lead frames 30 are each formed into necessary shapes like the terminal portion 31 and the base portion 32, and are connected to each other via a belt-like connecting portion (not shown).

Then, in a second step, insert molding is performed with these lead frames 30 as insert parts to form the inner member 41. The above-mentioned belt-like connecting portion is cut and removed at an appropriate timing.

Then, in a third step, the Hall IC 45 and the capacitors 50 are placed in each of the recess portions 41a to 41c of the inner member 41. Then, the three leads 45b to 45d provided to the Hall IC 45 are connected to the signal lead frame 30a, the grounding lead frame 30b and the power supply lead frame 30c by welding, respectively. Further, the two leads 51b, 51c provided to the first capacitor 51 are connected to the signal lead frame 30a and the grounding lead frame 30b by welding, respectively, and the two leads 52b, 52c provided to the second capacitor 52 are connected to the grounding lead frame 30b and the power supply lead frame 30c by welding, respectively. Thereby, the lead frame assembly 40 is formed. In the above, connection may be made by soldering instead of by welding.

Then, in a fourth step, as shown in FIG. 2, the recess portions 41a to 41c are filled with the potting material 60. At this time, the potting material 60 is provided to continuously fill in the part where the Hall IC 45 and the capacitors 50 are accommodated and in the wiring sections P of the leads 45b to 45d, 51b, 51c, 52b, 52c as well as the connection points C between the leads 45b to 45d, 51b, 51c, 52b, 52c and the lead frames 30.

Then, in a fifth step, insert molding is performed with the lead frame assembly 40 filled with the potting material 60 as the insert part. Thereby, the sensor housing 20 is formed. This sensor housing 20 is formed so that, as shown in FIG. 1, only the terminal portions 31 of the lead frames 30 are exposed to the outside and the remaining part of the lead frame assembly 40 is accommodated in the sensor housing 20. Moreover, this sensor housing 20 is formed so that the terminal portions 31 exposed to the outside are surrounded by the peripheral wall portion 23.

In a sixth step, the float 12 is connected to one end of the arm 14, and the other end thereof is fitted in the holder 16. Then, the annular magnet 17 is disposed inside the holder 16, and the holder 16 is attached to a predetermined position of the sensor housing 20. When this is done, a member such as a bearing is disposed inside the holder 16, and the holder 16 is rotatable with respect to the sensor housing 20.

Through a series of these steps, the liquid level sensor 10 according to the exemplary embodiment as shown in FIG. 1 is manufactured.

Next, the workings of the liquid level sensor 10 according to the exemplary embodiment will be described. When the liquid level sensor 10 according to the exemplary embodiment is used, for example, as a sensor that detects the liquid level of a fuel tank of a vehicle, there are cases where the liquid level sensor 10 sinks in the gasoline when the fuel tank is full.

Here, the lead frames 30 are a metal, and the sensor housing 20 is a resin. For this reason, a slight gap is formed between these. Therefore, when the liquid level sensor 10 sinks in the gasoline, fuel enters the sensor housing 20 from the exposed parts of the lead frames 30 of the sensor housing 20 (that is, the terminal portions 31). There are cases where fuel enters up to the neighborhood of the connection points C between the leads 45b to 45d, 51b, 51c, 52b, 52c of the Hall IC 45 and the capacitors 50 and the lead frames 30.

However, in the liquid level sensor 10 according to the exemplary embodiment, the recess portions 41a to 41c are formed in the wiring sections P in which the leads 45b to 45d, 51b, 51c, 52b, 52c of the Hall IC 45 and the capacitors 50 extend, and are filled with the potting material 60. Since the potting material 60 has the adhesiveness to the leads 45b to 45d 51b, 51c, 52b, 52c and the inner member 41, no gap is formed, so that the entrance of the fuel is prevented. Therefore, the fuel is held back by the potting material 60 and does not reach the body portions 45a and 50a of the Hall IC 45 and the capacitors 50, so that the Hall IC 45 and the capacitors 50 are prevented from breaking.

In particular, in the exemplary embodiment, the potting material 60 is continuously provided to include the connection points C between the lead frames 30 and the wiring sections P of the leads 45b to 45d, 51b, 51c, 52b, 52c. Consequently, the leads 45b to 45d, 51b 51c, 52b, 52c are covered with the potting material 60, so that it is possible to prevent a disconnection due to the resin for the sensor housing 20 exerting a load on the leads 45b to 45d, 51b, Sic, 52b, 52c during the insert molding of the sensor housing 20.

In addition, in the exemplary embodiment, the inner member 41 is made of the polyphenylene sulfide resin and the sensor housing 20 is made of the polyacetal resin. For this reason, the penetration of the gasoline into the resin is suppressed by the polyacetal resin, and the penetration into the resin of the alcohol contained in the gasoline and the moisture contained in the alcohol is suppressed by the polyphenylene sulfide resin. By this two-layer structure, the permeabilities of the gasoline, the alcohol and the moisture can be made less than one-fifth compared with when only one of the resins is used, whereby the Hall IC 45 and the capacitors 50 are protected.

Further, since the potting material 60 is made of fluorosilicone, perfluoroelastomer or perfluoroether having the adhesiveness that suppresses the penetration of alcohol and water as shown in FIG. 5, a three-layer structure of the polyacetal resin, the polyphenylene sulfide resin and fluorosilicone or the like is formed, whereby the Hall IC 45 and the capacitors 50 are protected.

As described above, according to the liquid level sensor 10 of the exemplary embodiment, since the recess portions 41a to 41c formed in the wiring sections P are filled with the potting material 60 having the insulation property and the adhesiveness to the leads 45b to 45d, 51b, 51c, 52b, 52c and to the inner member 41, even if fuel enters the sensor housing 20 from the exposed parts of the lead frames 30, the liquid is held back by the potting material 60 in the recess portions 41a to 41c and does not reach the body portions 45a, 51a and 52a of the Hall IC 45 and the capacitors 50. Thereby, the Hall IC 45 and the capacitors 50 can be prevented from being broken by the fuel entering from the exposed parts of the lead frames 30 without having to consider holding the rubber sealing member in a state of being compressed at the time of manufacture.

Moreover, since the recess portions 41a to 41c are formed to extend continuously to the connection points C at which the leads 45b to 45d, 51b, 51c, 52b, 52c are connected to the lead frames 30, and the recess portions 41a to 41c are filled with the potting material 60 such that the potting material 60 is continuously provided to include the connection points C, the leads 45b to 45d, 51b, 51c, 52b, 52c of the Hall IC 45 and the capacitors 50 are also covered with the potting material 60, so that it is possible to prevent a disconnection due to the resin exerting a load on the leads 45b to 45d, 51b, 51c, 52b, 52c of the Hall IC 45 and the capacitors 50 during the insert molding of the sensor housing 20.

Moreover, since the inner member 41 is made of the polyphenylene sulfide resin, the sensor housing 20 is made of the polyacetal resin and the potting material 60 is made of fluorosilicone, perfluoroelastomer or perfluoroether having the adhesiveness, expensive resins are used for the inside of the liquid level sensor 10. Thereby, cost can be suppressed compared with when expensive resins are used for the outside. Further, the Hall IC 45 and the capacitors 50 are protected by the two-layer structure of the polyacetal resin that suppresses the penetration of gasoline and the polyphenylene sulfide resin that suppresses the penetration of moisture and alcohol, so that the possibility can be suppressed that gasoline, or ethanol or the like mixed in the gasoline penetrates into the resin to reach the Hall IC 45 and the capacitors 50 and break the Hall IC 45 and the capacitors 50.

Moreover, by using a semiconductor part such as the Hall IC 45 for the sensor 10, a semiconductor part more vulnerable to liquid can be protected.

While the liquid level sensor 10 according to the exemplary embodiment has been described above, the present invention is not limited to this exemplary embodiment but may be modified variously without departing from the scope of the invention. For example, the present invention may be applied to a sensor always sinking in a liquid.

Moreover, while a liquid level sensor that detects the fuel level for vehicles is described in the above exemplary embodiment, the present invention is not limited to the use for vehicles but may be used for other purposes. Moreover, while a non-contact liquid level sensor is described in the above exemplary embodiment, the present invention is not limited to the non-contact type but may be a different type such as a contact type. Moreover, while the Hall IC 45 and the capacitors 50 are shown as an example of the electronic component, the electronic component may be other than them.

The present invention is applicable to variety of sensors other than a liquid level sensor. That is, the object to be detected by the sensor according to the present invention is not limited to the liquid level, but it is necessary only that the sensor has a structure where the detection element outputs an electric signal corresponding to a physical quantity related to the object to be detected or the amount of a change of the object to be detected.

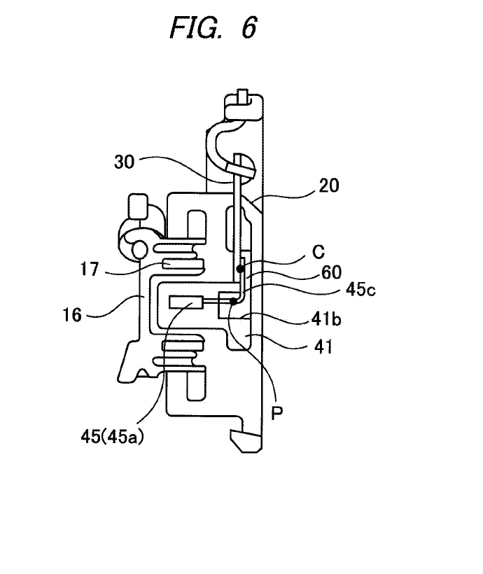

Further, the following structure may be provided: FIG. 6 is a cross-sectional view of the liquid level sensor 10 according to a modification of the exemplary embodiment. In FIG. 6, the same or similar elements are denoted by the same reference designations and descriptions thereof are omitted.

As shown in FIG. 6, in the modification, the body portion 45a and portions the leads 45b to 45d of the Hall IC 45 are embedded in the inner member 41. The leads 45b to 45d are drawn out from the bottom surface of the second recess portion 41b, and the second recess portion 41b is situated in the wiring section P. Also in this modification, the second recess portion 41b is filled with the potting material 60 described above. Thereby, fuel is held back by the potting material 60 and does not reach the body portion 45a of the Hall IC 45, so that the Hall IC 45 is prevented from breaking. The capacitors 50 may be structured similarly to the modification.

What is claimed is:

1. A sensor adapted to be used in liquid and configured to output an electric signal corresponding to a physical quantity related to an object to be detected or an amount of a change of the object to be detected, the sensor comprising:
an electronic component having a conductive lead and a body portion;
a first resin molded piece configured to receive and to hold the electronic component;
a lead frame held by the first resin molded piece and electrically connected to the lead of the electronic component; and
a second resin molded piece insert-molded with the electronic component, the first resin molded piece and the lead frame being insert parts such that a portion of the lead frame is exposed,
wherein the first resin molded piece comprises a recess portion at least in a wiring section in which the lead of the electronic component extends, and
wherein the recess portion is filled with a potting material having an insulation property and an adhesiveness to the lead and to the first resin molded piece.

2. The sensor according to claim 1, wherein the recess portion is formed to extend continuously to a connection point at which the lead is connected to the lead frame, and wherein the recess portion is filled with the potting material such that the potting material is continuously provided to include the connection point.

3. The sensor according to claim 1, wherein the sensor is adapted to be provided in a fuel tank of an automobile,
wherein the first resin molded piece is made of a polyphenylene sulfide resin,
wherein the second resin molded piece is made of a polyacetal resin, and
wherein the potting material is made of fluorosilicone, perfluoroelastomer having the adhesiveness or perfluoroether having the adhesiveness.

4. The sensor according to claim 1, further comprising:
a float floatable on a liquid surface; and
an annular magnet configured to rotate in accordance with a position of the float,
wherein the electronic component is a Hall integrated circuit disposed in a center of the magnet, the Hall integrated circuit comprising a Hall element to output an electric signal corresponding to a change of a magnetic flux density of a magnetic field passing through the Hall element as the magnet rotates.
